(19) United States
(12) Patent Application Publication
(10) Pub. No.: US 2005/0280632 A1
(43) Pub. Date: Dec. 22, 2005

(54) Detachable wireless presentation device

(75) Inventor: Jen-Chieh Tsan, Taipei (TW)

Correspondence Address: Mr. Peter F. Corless;Mr. Steven M. Jensen, EDWARDS & ANGELL, LLP, 101 Federal Street, Boston, MA, 02110, US

(73) Assignee: Inventec Corporation

(21) Appl. No.: 10/873,080

(22) Filed: Jun. 21, 2004

(51) Int. Cl. G09G 5/08

(52) U.S. Cl. 345/158

(57) ABSTRACT

A detachable wireless presentation device is provided, which not only functioned as a touchpad of a presentation playing apparatus but also allows user to operate the presentation playing apparatus in a wireless remote manner. The presentation device comprises left and right buttons replacing the original function of a mouse, last/next page control buttons, a laser pointer button and a touch-control interface. When the user wishes to deliver a presentation by projecting output image from the presentation playing apparatus to a display screen via a projector, presentation progress involving such as changing a presented page or indicating the position of the currently presented content, can be directly carried out in a wireless manner by operating the presentation playing apparatus via the presentation device. Thereby the projecting image of the presentation playing apparatus can be changed immediately in accordance with the presentation flow and thus enhances efficiency and effectiveness for delivering the presentation.

### FIELD OF THE INVENTION

The present invention relates to a wireless input device, and more particularly, to a detachable wireless presentation device for user to remotely control a presentation playing apparatus by changing the output page of the presentation and indicating the position of the currently presented content.

### DESCRIPTION OF THE PRIOR ART

Nowadays is a business-marketing era. In many occasions such as product introductory seminars, company internal conferences, and lectures, various presentation techniques are employed to make the marketing products, expressed opinions, or communicated knowledge more understandable and impressive to audiences. Normally a presentation is carried out by employing a presentation playing apparatus (such as a notebook) in conjunction with a projector for projecting the images output from the notebook to a display screen. However, during the presentation, the speaker often holds a laser pointer to indicate the position of the currently presented content, while an assistant changes the presentation pages according to the delivery speed of the speaker. Thus, an unspoken consensus must be established between the speaker and the assistant, in order for the presentation to be smoothly carried out. If the speaker and the assistant cannot cooperate, the flow of the presentation is disturbed, so are the audiences. In order to avoid this lack of cooperation, some speakers play a dual role, i.e. giving presentation while attending to the presentation playing apparatus to change the pages being presented. As the speaker attends to the presentation playing apparatus off the stage, the flow of the presentation is awkwardly paused. In addition, times and physical strength are spent traveling back and forth between the stage and the presentation playing apparatus. The interrupted presentation decreases the efficiency and effectiveness of the whole presentation. Thus, a solution that resolves these problems is in great need.

### SUMMARY OF THE INVENTION

In order to solve the problems of the prior art, a primary objective of the present invention is to provide a detachable wireless presentation device by detaching a touchpad from a presentation playing apparatus. The detachable wireless presentation device permits remote control of the presentation playing apparatus in a wireless manner, consequently improving the efficiency of delivering a presentation.

Another objective of the present invention is to provide a detachable wireless presentation device with last and next page control buttons, allowing user to directly and remotely change the output page of the presentation playing apparatus in a wireless manner, such that the time spent traveling back and forth between a podium and the presentation playing apparatus is eliminated.

Yet another objective of the present invention is to provide a detachable wireless presentation device with a touch-control interface replacing the function of a mouse. This allows user to select and operate function interface of the presentation playing apparatus in a wireless manner.

In order to achieve the above objectives, the present invention provides a detachable wireless presentation device.

A detachable wireless presentation device of the present invention comprises: (1) a touch-control interface used as a pressure pointing sensing interface, via which a user can direct a cursor position in an output image of a presentation playing apparatus; (2) a laser pointer button for irradiating a light beam onto presentation image to indicate the position of the currently presented content; (3) last page control button for changing an output page of the presentation playing apparatus to a last page in accordance to current presentation progress; (4) next page control button for changing an output page of the presentation playing apparatus to a next page in accordance to current presentation progress; (5) left function button replacing a left button of a mouse for selecting on an function menu of the presentation playing apparatus the functions provided thereon; and (6) right function button replacing a right button of a mouse for selecting on an function menu of the presentation playing apparatus the functions provided thereon.

### BRIEF DESCRIPTION OF THE DRAWINGS

FIG. 1 shows a schematic diagram of a detachable wireless presentation device and its relationship with respect to a notebook, according to one embodiment of the present invention.

### DETAILED DESCRIPTION OF THE PREFERRED EMBODIMENT

The descriptions below of specific embodiments are to illustrate the present invention. Others skilled in the art can easily understand other advantages and features of the present invention from contents disclosed in this specification. The present invention can be carried out or applied through different embodiments. For example, the notebook is replaced by a desktop computer, a flat-panel computer or other information devices; the function buttons are replaced with a control roller; or the touch-control interface is replaced with a trackball. Every details of this specification can be modified based on different viewpoints and applications yet still within the scope of the present invention.

The embodiments below are only to further illustrate aspects of the present invention in details; they should not be construed as to limit the scope of the present invention in any way.

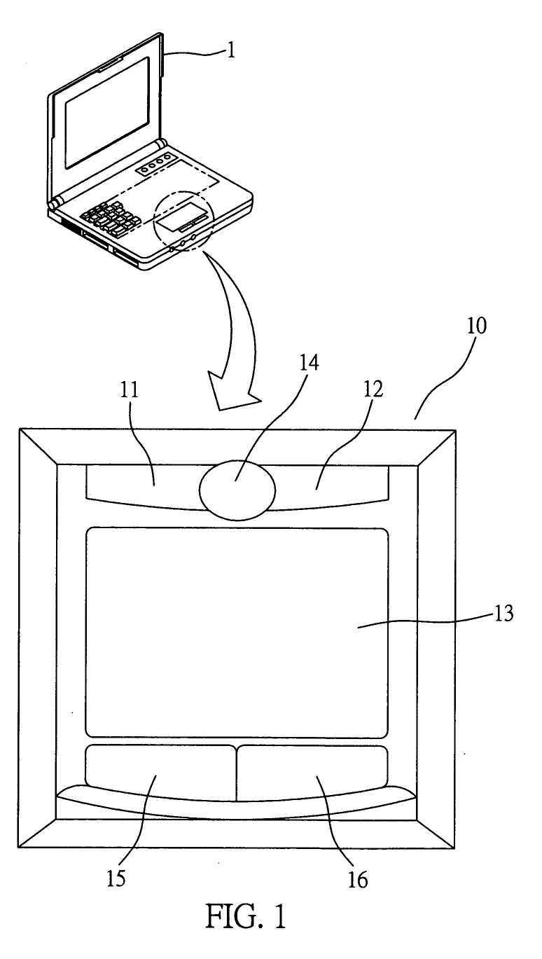

In the embodiment below, a detachable wireless presentation device according to the present invention is provided on a notebook. It normally functions as an input touchpad for the notebook; and during presentation, it can be detached from the notebook and used as a wireless presentation device. FIG. 1 shows a schematic diagram of a detachable wireless presentation device 10 and its relationship with respect to a notebook 1 according to one embodiment of the present invention. It should be noted that FIG. 1 is only an illustration of an embodiment of the present invention; it is not intended to limit the present invention to the appearance or buttons arrangement shown in FIG. 1. As shown in FIG. 1, the wireless presentation device 10 of the present invention comprises a Last Page control button 11, a Next Page control button 12 (or alternatively, the Last/Next Page control buttons can be controlled by a roller), a touch-control interface 13, a laser pointer button 14, Left function button 15 and Right function button 16. When a user wishes to make a presentation to audiences via the detachable wireless presentation device 10, first the detachable wireless presentation device 10 has to be detached from a placement a of the notebook 1, that is, from the placement of the touch pad. In placement a, a wireless receiver and a battery charger (both not shown) are further provided, so that the notebook 1 can perform corresponding control actions in response to receiving wireless signals from the detachable wireless presentation device 10, and to supply power to rechargeable batteries (not shown) in the detachable wireless presentation device 10. After the user turns on the power of the notebook 1 and loads a presentation software (e.g. a PowerPoint), he/she may use the touch-control interface of the detachable wireless presentation device 10 by touching the pressure pointing sensing interface provided thereon to generate pressure, which in turn controls cursor movement and selection position shown on an output image of the notebook 1. Furthermore, the image output by the notebook 1 is also shown on a display screen (not shown) via a projector (not shown). Thereby, the user may directly control the direction of the moving cursor and the selection position via the touch-control interface 13, according to the images displayed on the display screen. When operated in conjunction with the Left function button 15 and Right function button 16 to select actions to be performed, the detachable wireless presentation device 10 can be used to perform all the control functions of a mouse originally provided for the notebook 1.

In addition, if the user (i.e. the speaker) wishes to indicate a position of the currently presenting content, he/she may press down the laser pointer button 14 on the detachable wireless presentation device 10, then a pointing beam of light from the detachable wireless presentation device 10 can be irradiated on the display screen. This allows the user to point to a particular position of the presented content via directing the pointing beam of light. If the user wishes to change a page of the content on the display screen, he/she can directly change the projecting page in accordance with the current presentation progress by accessing the Last Page button 11 and the Next Page button 12, without accessing the Page Up and Page Down buttons provided in notebook 1. Thereby, the costs of personnel (e.g. an assistance for operating the notebook 1) and the time spent traveling back and forth are eliminated.

The foregoing embodiments were chosen and described in order to best explain the principles of the invention and its practical application, it is not intended to limit the scope of the present invention in any way, and to thereby enable others skilled in the art to best utilize the invention and various embodiments with various modifications as are suited to the particular use contemplated. It is intended that the scope of the invention be defined by the claims appended hereto and their equivalents.

1. A detachable wireless presentation device used as an input interface for a presentation playing apparatus comprising:
a touch-control interface used as a pressure pointing sensing interface, via which a user can direct a cursor position in an output image of the presentation playing apparatus;
a laser pointer button for irradiating a beam of light onto the presenting image to indicate the position of the currently presented content; and
last and next page control buttons for changing an output page of the presentation playing apparatus in accordance to current presentation progress.

2. The detachable wireless presentation device as claimed in claim 1, wherein the presentation playing apparatus is a notebook.

3. The detachable wireless presentation device as claimed in claim 2, wherein the wireless presentation device can function as a touchpad for the notebook.

4. The detachable wireless presentation device as claimed in claim 1, further comprising left and right function buttons.

5. The detachable wireless presentation device as claimed in claim 1, wherein the power of the detachable wireless presentation device is supplied from at least one rechargeable battery.

6. The detachable wireless presentation device as claimed in claim 5, wherein the at least one rechargeable battery is recharged from a power supplied by the presentation playing apparatus.

7. The detachable wireless presentation device as claimed in claim 1, wherein the touch-control interface is replaced with a trackball.

8. The detachable wireless presentation device as claimed in claim 1, wherein the last page control button and next page control button are replaced with a control roller.

9. The detachable wireless presentation device as claimed in claim 4, wherein during the presentation, the left and right function buttons can replace left and right buttons of a mouse.
